(19) United States
(12) Patent Application Publication
(10) Pub. No.: US 2012/0105907 A1
(43) Pub. Date: May 3, 2012

(54) SYSTEM AND METHOD FOR MANAGING PRINT JOBS

(75) Inventor: MING-JING SONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/221,849

(22) Filed: Aug. 30, 2011

(30) Foreign Application Priority Data
Nov. 2, 2010 (CN) 201010528482.X

(51) Int. Cl. G06K 15/02

(52) U.S. Cl. 358/1.15

(57) ABSTRACT

In a system and method for managing print jobs of a printer, when the printer acquires a print job, the print job is stored in a buffer having a corresponding priority level of the print job. A first buffer that stores one or more print jobs and has a higher priority level than other buffers currently storing print jobs is selected. A first print job stored in the first buffer is executed. If a second print job is stored in a buffer having a higher priority level than the first buffer when the first print job is being executed, the first print job is suspended and the second print job is executed.

### BACKGROUND

1. Technical Field

Embodiments of the present disclosure relate generally to print job management, and more particularly, to a system and method for managing print jobs of a printer.

2. Description of Related Art

Printers are often shared by several workers in offices for cost savings. When several users want to print files, the printer executes print jobs according to a submission order of the print jobs. However, when the printer is printing a current file that has many pages, such as a thousand pages, and a user has a very important file that needs to be printed urgently, the user must either wait or cancel the current print job. What is needed, therefore, is a method for managing the print jobs of the printer to overcome the limitations described.

### BRIEF DESCRIPTION OF THE DRAWINGS

FIG. 1 is a block diagram of one embodiment of a printer including a management system for managing print jobs from computers.

FIG. 2 is an example of buffers of FIG. 1.

FIG. 3 is a block diagram of one embodiment of functional modules of the management system included in the printer of FIG. 1.

FIG. 4 is a flowchart of one embodiment of a method for managing the print jobs from the computers of FIG. 1.

FIG. 5 is a flowchart of one embodiment of block S20 of FIG. 4.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

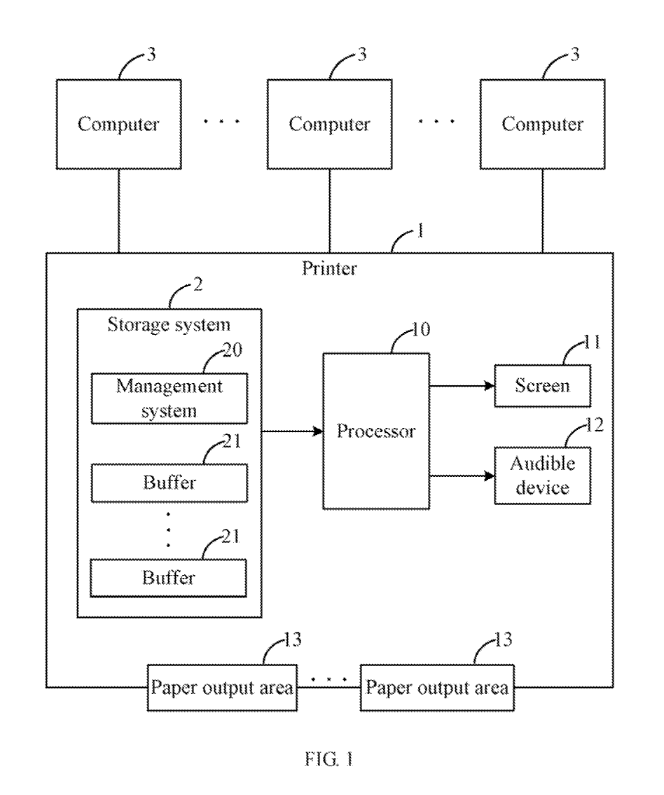

FIG. 1 is a block diagram of one embodiment of a printer 1 including a management system 20 for managing print jobs from computers 3. In the embodiment, the printer 1 communicates with one or more computers 3 via a local area network. Users submit print jobs to the printer 1 using the computers 3. Each of the print jobs can be set to a priority level when the users submit the print jobs. For example, a first file is submitted with a first priority level, and a second file is then submitted with a second priority level, if the first file has a higher priority level than the second file, the first file will be printed before the second file.

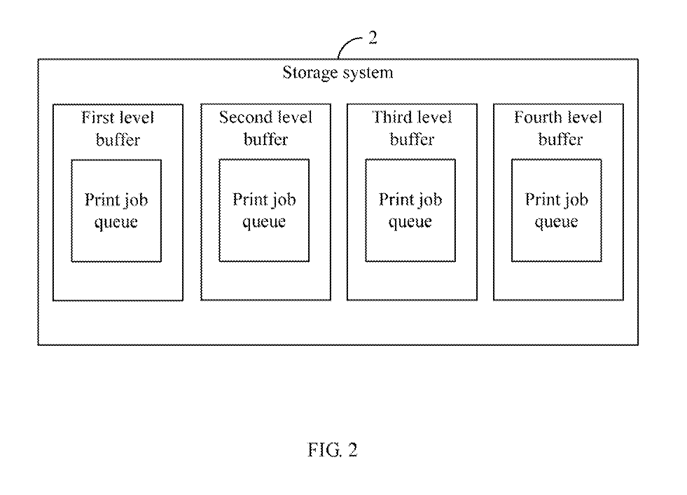

In the embodiment, the printer 1 includes a storage system 2, at least one processor 10, a screen 11, an audible device 12, and paper output areas 13. The storage system 2 further includes several buffers 21 (e.g., flash memory, RAM) for storing print jobs having different priority levels. For example, as shown in FIG. 2, the buffers 21 include first through fourth level buffers with the order of priority being the first buffer having lowest priority and the fourth the highest priority. Incoming print jobs are sorted into the corresponding buffers 21 according to their priority levels. For example, a print job having a first priority level should be stored in the first level buffer. Additionally, the print jobs are stored in the buffers 21 according to first in first out. That is, print jobs in a particular buffer are printed in the order of their arrival.

The screen 11 is operable to display print information, such as a status of a print job currently printing, a name of a user who submitted the print job, and an internet protocol (IP) address of the computer 3 from which the current printing print job was submitted.

The audible device 12 is operable to alert users to conditions needing attention such as an empty paper tray.

Each buffer 21 has a corresponding paper output area 13 to keep print jobs organized according to their priority level.

The management system 20 may be in the form of one or more programs that are stored in the storage system 2, and can manage the print jobs of the printer 1. It should be apparent that FIG. 1 is just one example of the printer 1 that can be included with more or fewer components that shown in other embodiments, or a different configuration of the various components.

In one embodiment, the storage system 2 may be random access memory (RAM) for temporary storage of information, and/or a read only memory (ROM) for permanent storage of information. In other embodiments, the storage system 2 may also be an external storage device, such as a hard disk, a storage card, or a data storage medium. The at least one processor 10 executes computerized operations of the printer 1 and other applications, to provide functions of the printer 1.

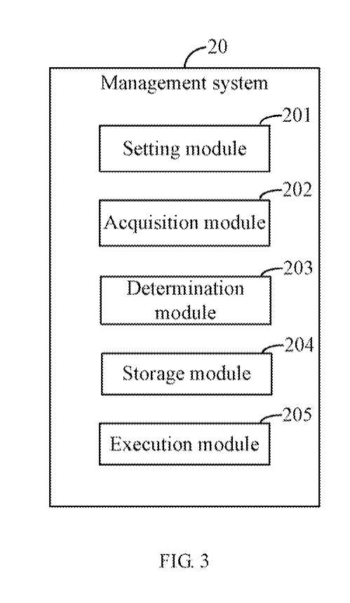

FIG. 3 is a block diagram of one embodiment of functional modules of the management system 20 included in the printer 1 of FIG. 1. The management system 20 may include a plurality of functional modules each comprising one or more programs or computerized codes that can be accessed and executed by the at least one processor 10. In one embodiment, the management system 20 includes a setting module 201, an acquisition module 202, a determination module 203, a storage module 204, and an execution module 205. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

The setting module 201 is operable to set authority of a user to select the priority levels for the print jobs. If a user has a highest authority, the user can select any priority level for the print jobs, and if a user has a lowest authority, the user only can select a lowest priority level for the print jobs. The setting module 201 may be used to set a relationship between authority and a user name, or set relationships between authority and IP addresses of each of the computers 3. For example, the setting module 201 can set that a user with a user name “Lucy” has the highest authority.

The acquisition module 202 is operable to acquire a print job when the user submits the print job from a computer 3, and acquire a user name of the user or the IP address of the computer 3. If the user selects a priority level for the print job, the acquisition module 202 further acquires the selected priority level of the submitted print job.

The determination module 203 is operable to determine a priority level of the print job according to the selected priority level and the authority of the user. The determination module 203 determines whether the user has the authority to select the selected priority level for the print job according to the user name or the IP address. If the user has the authority to select the selected priority level, the determination module 203 determines that the print job has the selected priority level. If the user does not have authority to select the selected priority level, the determination module 203 determines that the print job has a default lowest priority level. If the user does not select a priority level for the print job, the determination module 203 assigns the default lowest priority level as the priority level of the print job.

The storage module 204 is operable to store the print job to a buffer 21 having the corresponding priority level of the print job.

The determination module 203 is further operable to selects one of the buffers 21 that stores one or more print jobs as a first buffer, and determines whether the first buffer has a higher priority level than other buffers currently storing print jobs.

The execution module 205 is operable to execute a first print job stored in the first buffer if the first buffer has a higher priority level than other buffers currently storing print jobs.

The determination module 203 is further operable to determine whether the first print job has been executed completely. If the first print job has not been executed completely, the determination module 203 determines whether a second print job is stored in any buffer having a higher priority level than the first buffer.

The execution module 205 suspends the first print job after a current page of the first print job is finished printing and executes the second print job if the second print job is stored in a buffer having a higher priority level than the first buffer and it is not a last page of the first print job that is currently printing. For example, assuming that a first file is being printed when a second file having a higher priority level than the first file is stored in a corresponding buffer 21, the first file printing is suspended unless it is a last page of the first file that is being printed (in which case the first file is allowed to be finished), and the second file is to be printed.

When there is no print job stored in any buffer having a higher priority level than the first buffer, the determination module 203 continues checking whether the first print job has been executed completely.

When the first print job has been executed completely, the determination module 203 determines whether the buffers 21 store other print jobs. If the buffers 21 store other print jobs, the execution module 205 executes a new print job from the buffers 21 according to priority, and if no priorities have been set, then according to first in first out.

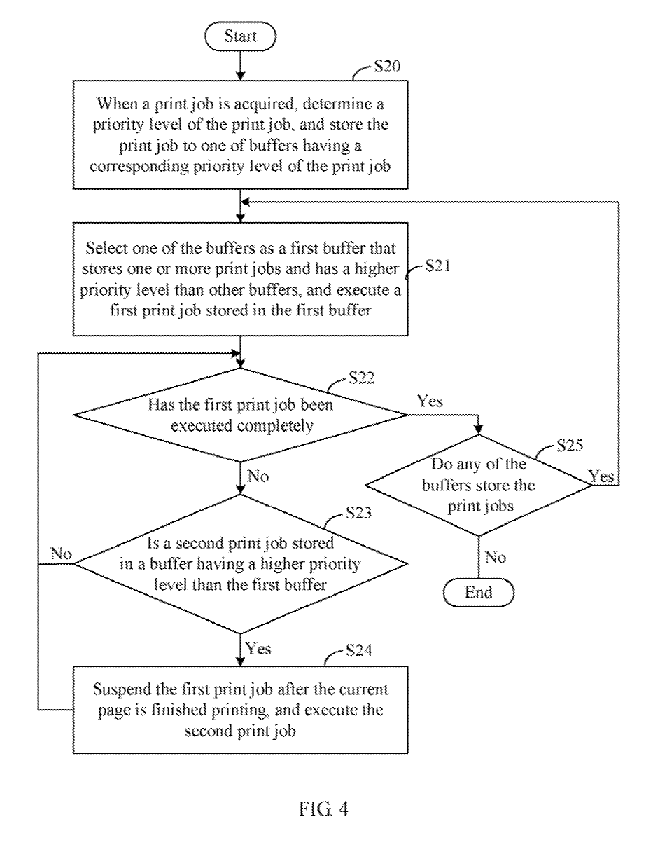

FIG. 4 is a flowchart of one embodiment of a method for managing the print jobs of the printer 1 from the computers 3 of FIG. 1. Depending on the embodiment, additional blocks may be added, others removed, and the ordering of the blocks may be changed. Before block S20, the setting module 201 sets authority of a user to select the priority levels for the print jobs. The setting module 201 may set a relationship between authority and a user name, or set relationships between authority and IP addresses of each of the computers 3.

In block S20, the determination module 203 determines a priority level of a print job when the acquisition module 202 acquires the print job submitted by the user from a computer 3, and the storage module 204 stores the print job to a buffer 21 having a corresponding priority level of the print job.

In block S21, the determination module 203 selects one of the buffers 21 that stores one or more print jobs as a first buffer, and determines whether the first buffer has a higher priority level than other buffers currently storing print jobs. The execution module 205 executes a first print job stored in the first buffer if the first buffer has a higher priority level than other buffers currently storing print jobs.

In block S22, the determination module 203 determines whether the first print job has been executed completely. If the first print job has not been executed completely, block S23 is implemented. If the first print job has been executed completely, block S25 is implemented.

In block S23, the determination module 203 determines whether a second print job is stored in any buffer having a higher priority level than the first buffer. If the second print job is stored in a buffer having a higher priority level than the first buffer, block S24 is implemented. If there is no print job stored in any buffer having a higher priority level than the first buffer, the flow may return to the block S22.

In block S24, The execution module 205 suspends the first print job after a current page of the first print job is finished printing, and executes the second print job that is stored in the buffer having a higher priority level than the first buffer if it is not a last page of the first print job that is currently printing, and the flow return to the block S22. If it is the last page of the first print job that is currently printing, the first print job is allowed to be finished.

In block S25, the determination module 203 determines whether any of the buffers 21 store print jobs. If there are print jobs stored in any of the buffers 21, the flow return to the block S21, and the execution module 205 executes a new print job stored in the buffers 21 according to priority, and if no priorities have been set, then according to first in first out. If no print job is stored in buffers 21, the flow ends.

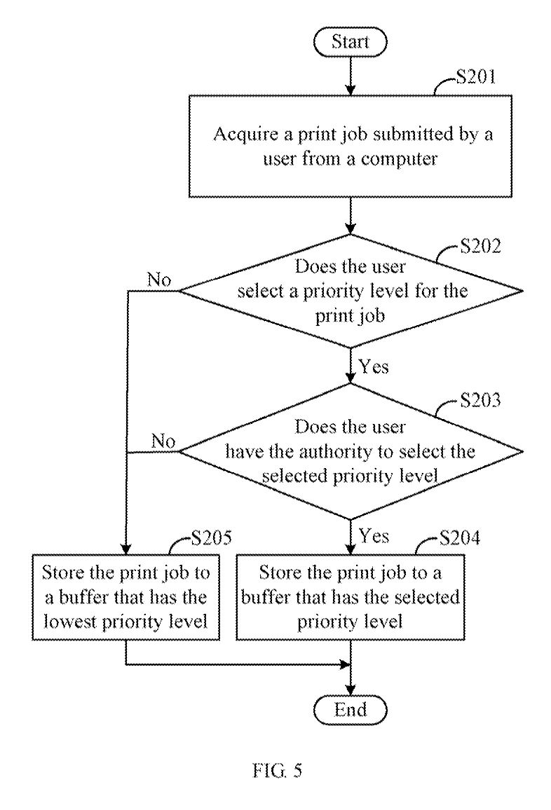

FIG. 5 is a flowchart of one embodiment of block S20 of FIG. 4. Depending on the embodiment, additional blocks may be added, others removed, and the ordering of the blocks may be changed.

In block S201, the acquisition module 202 acquires a print job submitted by a user from one of the computers 3, and acquires a user name of the user or an IP address of the computer 3.

In block S202, the determination module 203 determines whether the user selects a priority level for the print job. If the user selects a priority level for the print job, the acquisition module 202 further acquires the selected priority level, and block S203 is implemented. If the user does not select a priority level for the print job, block S205 is implemented.

In block S203, the determination module 203 determines whether the user has the authority to select the selected priority level according to the user name or the IP address. If the user has the authority to select the selected priority level, block S204 is implemented. If the user does not have authority to select the selected priority level, block S205 is implemented.

In block S204, the determination module 203 determines that the print job has the selected priority level. The storage module 204 stores the print job to a buffer that has the selected priority level, such as the highest priority level.

In block S205, the determination module 203 determines that the print job has a default lowest priority level. The storage module 204 stores the print job to one of the buffers 21 that has the lowest priority level.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A printer, comprising:
at least one processor;
a storage system comprising a plurality of buffers for storing print jobs having different priority levels; and
one or more programs stored in the storage system and executable by the at least one processor, the one or more programs comprising:
an acquisition module operable to acquire a print job submitted by a user from a computer;
a determination module operable to determine a priority level of the print job;
a storage module operable to store the print job to one of the buffers having the corresponding priority level of the print job;
the determination module further operable to select a buffer that stores one or more print jobs as a first buffer, and determine whether the first buffer has a higher priority level than other buffers currently storing print jobs;
an execution module operable to execute a first print job stored in the first buffer if the first buffer has a higher priority level than other buffers currently storing print jobs;
the determination module further operable to determine whether a second print job is stored in any buffer having a higher priority level than the first buffer when the first print job is being executed;
the execution module further operable to suspend the first print job and execute the second print job if the second print job is stored in a buffer having a higher priority level than the first buffer.

2. The printer of claim 1, further comprising a setting module that is operable to set an authority of the user to select the priority levels for the print jobs.

3. The printer of claim 1, wherein the acquisition module is further operable to acquire a selected priority level if the user selects a priority level for the print job.

4. The printer of claim 3, wherein the determination module is further operable to determine whether the user has the authority to select the selected priority level for the print job according to a user name of the user or an internet protocol address of the computer.

5. The printer of claim 4, wherein the determination module is further operable to determine that the print job has the selected priority level if the user has the authority to select the selected priority level for the print job.

6. The printer of claim 4, wherein the determination module is further operable to determine that the print job has a default lowest priority level, upon the condition that the user does not have authority to select the selected priority level or the user does not select a priority level for the print job.

7. The printer of claim 1, wherein each of the buffers has a corresponding paper output area to keep print jobs organized according to their priority level.

8. A method for managing print jobs of a printer, the printer comprising a plurality of buffers for storing print jobs having different priority levels, the method comprising:
(a) acquiring a print job submitted by a user from a computer, determining a priority level of the print job, storing the print job to one of the buffers having the corresponding priority level of the print job;
(b) selecting a buffer that stores one or more print jobs as a first buffer, and determining whether the first buffer has a higher priority level than other buffers currently storing print jobs;
(c) executing a first print job stored in the first buffer if the first buffer has a higher priority level than other buffers currently storing print jobs;
(d) determining whether a second print job is stored in any buffer having a higher priority level than the first buffer when the first print job is being executed;
(e) suspending the first print job and executing the second print job if the second print job is stored in a buffer having a higher priority level than the first buffer.

9. The method of claim 8, further comprising:
setting an authority of the user for selecting the priority levels for the print jobs.

10. The method of claim 8, wherein the block (a) further comprises:
acquiring a selected priority level if the user selects a priority level for the print job.

11. The method of claim 10, wherein the block (a) further comprises:
determining whether the user has the authority to select the selected priority level for the print job according to a user name of the user or an internet protocol address of the computer.

12. The method of claim 11, wherein the block (a) further comprises:
determining that the print job has the selected priority level if the user has the authority to select the selected priority level for the print job.

13. The method of claim 11, wherein the block (a) further comprises:
determining that the print job has a default lowest priority level, upon the condition that the user does not have authority to select the selected priority level or the user does not select a priority level for the print job.

14. A non-transitory storage medium storing a set of instructions, the set of instructions capable of being executed by a processor of a printer, causes the printer to execute a method for managing print jobs, the printer comprising a plurality of buffers for storing print jobs having different priority levels, the method comprising:
(a) acquiring a print job submitted by a user from a computer, determining a priority level of the print job, storing the print job to one of the buffers having the corresponding priority level of the print job;
(b) selecting a buffer that stores one or more print jobs as a first buffer, and determining whether the first buffer has a higher priority level than other buffers currently storing print jobs;
(c) executing a first print job stored in the first buffer if the first buffer has a higher priority level than other buffers currently storing print jobs;
(d) determining whether a second print job is stored in any buffer having a higher priority level than the first buffer when the first print job is being executed;
(e) suspending the first print job and executing the second print job if the second print job is stored in a buffer having a higher priority level than the first buffer.

15. The medium of claim 14, wherein the method further comprises:
setting an authority of the user for selecting the priority levels for the print jobs.

16. The medium of claim 14, wherein the block (a) further comprises:
acquiring a selected priority level if the user selects a priority level for the print job.

17. The medium of claim 16, wherein the block (a) further comprises:
determining whether the user has the authority to select the selected priority level for the print job according to a user name of the user or an internet protocol address of the computer.

18. The medium of claim 17, wherein the block (a) further comprises:
determining that the print job has the selected priority level if the user has the authority to select the selected priority level for the print job.

19. The medium of claim 17, wherein the block (a) further comprises:
determining that the print job has a default lowest priority level, upon the condition that the user does not have authority to select the selected priority level or the user does not select a priority level for the print job.
